(19) United States
(12) Patent Application Publication
(10) Pub. No.: US 2024/0249188 A1
(43) Pub. Date: Jul. 25, 2024

(54) ONLINE DYNAMICAL PROMPT POOL FOR CONTINUAL LEARNING

(71) Applicant: Dell Products L.P., Round Rock, TX (US)

(72) Inventors: Isabella Costa Maia, São Paulo (BR); Karen Stéfany Martins, Belo Horizonte (BR); Pablo Nascimento da Silva, Niterói (BR); Werner Spolidoro Freund, Rio de Janeiro (BR)

(21) Appl. No.: 18/159,388

(22) Filed: Jan. 25, 2023

(51) Int. Cl. G06N 20/00

(52) U.S. Cl. CPC G06N 20/00

(57) ABSTRACT

One example method includes deploying a prompt vector space that includes a prompt pool including vectors for T number of prompts representing T number of tasks that are performed by an ML model. Each prompt encodes information about one of the tasks. An orthogonal vector space is calculated as an orthogonal complement to the prompt vector space and includes vectors that are orthogonal to the vectors forming the prompts of the prompt pool. An encoded task input of the ML model is monitored to determine if the encoded task input matches one of the vectors in the orthogonal vector space. When it is determined that the encoded task input matches one of the vectors in the orthogonal vector space, the size of the prompt pool is dynamically increased and the ML model is automatically retrained to account for changes made to the prompt pool by increasing the prompt pool's size.

### FIELD OF THE INVENTION

Embodiments of the present invention generally relate to continual learning processes. More particularly, at least some embodiments of the invention relate to systems, hardware, software, computer-readable media, and methods for automatically incorporating new tasks without prior knowledge of the task and then training a continual learning model.

### BACKGROUND

Continual learning is a machine process that uses models that can re-use and retain knowledge from different tasks and data distributions. In other words, a single model can perform many different tasks while using the dataset for each task only once. Continual learning models focuses on learning new tasks without forgetting previous ones, therefore retaining knowledge, and avoiding catastrophic forgetting. Thus, continual learning models allow for the reuse of knowledge between related tasks for better generalization. However, existing continual learning models are based on a fixed-size memory space which contains a representation of each one of the tasks, implying knowledge of each one of the tasks since a continual learning model's conception. Accordingly, existing continual learning models are unable to keep the model updated with new tasks without knowing beforehand how many tasks the model will be confronted with or when the new tasks arrive at the model.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a continual learning model according to embodiments disclosed herein;

FIGS. 2A-2D disclose aspects of a framework that allows the prompt pool of the continual learning model of FIG. 1 to be dynamically increased and for the model to be automatically retrained according to embodiments disclosed herein;

FIG. 3 illustrates a flowchart of an example method for dynamically increasing a prompt pool and automatically retraining a ML model; and

FIG. 4 illustrates an example computing entity operable to perform any of the disclosed methods, processes, and operations.

### DETAILED DESCRIPTION OF SOME EXAMPLE EMBODIMENTS

Embodiments of the present invention generally relate to continual learning processes. More particularly, at least some embodiments of the invention relate to systems, hardware, software, computer-readable media, and methods for automatically incorporating new tasks without prior knowledge of the task and then training a continual learning model.

In general, example embodiments of the invention include deploying in a machine-learning (ML) model, such as a continual learning model, a prompt vector space that includes a prompt pool including vectors for T number of prompts representing T number of tasks that are performed by the ML model. Each prompt encodes information about one of the tasks. An orthogonal vector space is calculated as an orthogonal complement to the prompt vector space and includes vectors that are orthogonal to the vectors forming the prompts of the prompt pool. An encoded task input of the ML model is monitored to determine if the encoded task input matches one of the vectors in the orthogonal vector space. When it is determined that the encoded task input matches one of the vectors in the orthogonal vector space, the size of the prompt pool is dynamically increased, and the ML model is automatically retrained to account for changes made to the prompt pool by increasing the prompt pool's size.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, the continual learning model of the current invention is advantageously able to be implemented in a dynamic environment such as, but not limited to, a smart logistics warehouse where multiple forklifts and/or Autonomous Mobile Robots (AMR) perform an increasing number of tasks without knowing beforehand when or how many times new tasks or changes in current task behaviors can occur. The continual learning model of the current invention is able to be updated to handle new scenarios. This includes the ability to maintain previous knowledge. For example, new entities such as new forklifts or AMRs may be added to the smart logistics warehouse and new tasks are performed while the previous entities and tasks are still part of the smart environment. Accordingly, the continual learning model of the current invention is able to constantly be updated to recognize new threads without forgetting how to predict previous ones.

In dynamic complex environments such as the smart logistics warehouse it is often difficult or unfeasible to predict from beginning all the possible threads a model can experience. To allow generalization in such scenarios, the continual learning model of the current invention is advantageously capable of incorporating a new task knowledge whenever data arrives from new thread without any beforehand knowledge of the new task. Thus, continual learning model of the current invention is capable of learning new tasks without being limited to a constant memory setup, which enhances system computational and statistical efficiencies. The continual learning model of the current invention is able to automatically adapt itself to attend to the new needs of a changed environment and to automatically identify a new thread and to return to train mode upon this event, so to be deployed again right after.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of Continual Learning

Continual learning, also known as lifelong learning, sequential learning, or incremental learning, is a machine learning (ML) process that aims to learn new tasks continuously and adaptively by adding knowledge to the model without sacrificing any previously acquired knowledge. Unlike traditional ML architectures that focus on solving a single task at a time, continual learning allows training a single model to perform many tasks using less computational power and model storage. It thus deals with the stability-plasticity dilemma, which focuses on accumulating knowledge (plasticity) without catastrophically forgetting prior knowledge (stability).

A single model capable of performing multiple tasks takes advantage of learned concepts such as forward and backward transfer. The knowledge earlier acquired is used in the new tasks, and the new task examples improve already learned ones, which avoid restarting the training process from zero and leads to better generalization.

Generally, continual learning is divided in three scenarios: domain-, task- and class-incremental learning. In the first one, tasks have the same classes, but input distributions are different. In task-incremental learning, the model is informed about which task needs to be performed, allowing models with task-specific components. Differently, in class-incremental, models must be able to both solve each task seen so far and infer which one they are presented with. All three scenarios assume that task boundaries are known during training, which can be a disadvantage when task identity is not available. Task agnostic continual learning focuses on the scenario where task boundaries are not known during training.

### A. 1 Prompting for Continual Learning

Some continual learning models focus on either adapting the model parameters or the model architecture to conform to non-stationary data distributions, where catastrophic forgetting is a challenge. These methods typically rely on rehearsal buffers (reuse past data to train the model when data from a new task arrives) and known task identity. However, in real life scenarios, task identity is not always known and keeping previously used data might be prohibitive for both privacy and memory constrains.

Accordingly, some continual learning models implement the concept of a prompt. In operation, a prompt is a learnable parameter that is added to the input received from a task that is be performed by the continual learning model. The prompt is then configured to condition the continual learning model to perform the task related to the prompt. For example, if the input is “I like this car” for a sentiment analysis task, then a prompt may transform the input to “I like this car. It is X”, where “X” is an empty slot to be predicted (e.g., fast, shiny, etc.) and “it is X” is the prompt. Thus, the sentiment analysis will be conditioned to predict outcomes that satisfy the prompt.

Some continual learning models implement a prompt pool, which is a memory space that typically contains multiple task specific prompts. Since each prompt is task specific, the implementation of the prompt pool allows the continual learning model to perform many tasks and to accumulate knowledge about past tasks and then to use this knowledge for other similar tasks. For example, in the sentiment analysis task discussed previously, the prompt “it is X” can be used for similar sentiment analysis tasks.

Some continual learning models implement prompt pools that encode both general information and task-specific knowledge. Other continual learning models encode task-invariant knowledge in a unique general prompt and implement prompt pools that contain exclusively task-specific prompts.

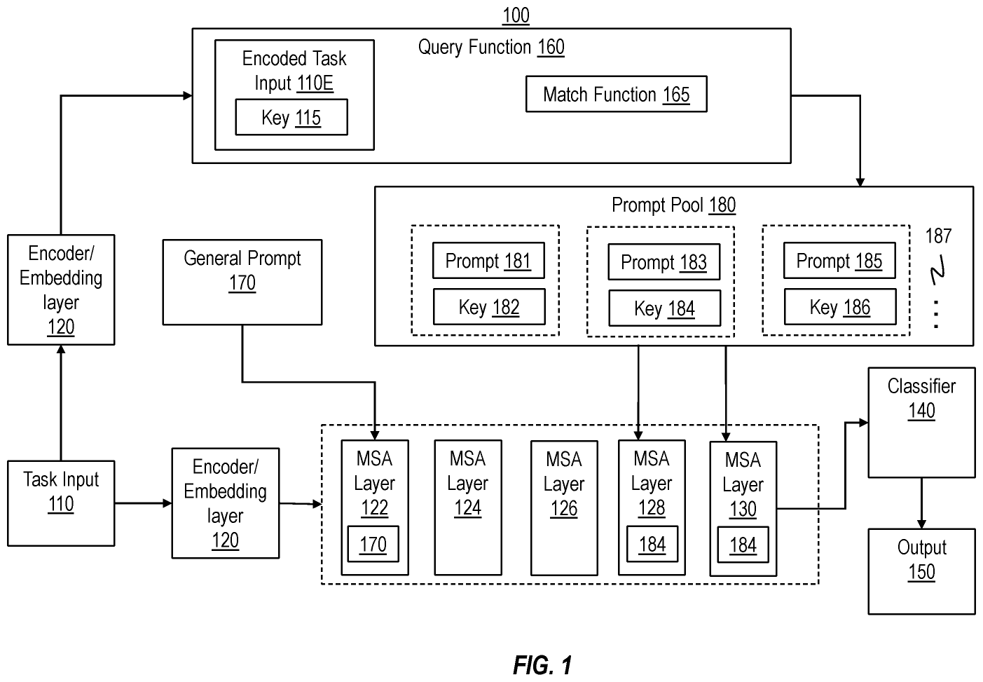

FIG. 1 illustrates an embodiment of a continual learning model 100 (also referred hereinafter as “model 100”) that implements a general prompt and a prompt pool of exclusively task specific prompts. In the illustrated embodiment, the model 100 comprises a pretrained vision transformer model that includes an encoding/embedding layer 120, multiple Multi-Head Self-Attention (MSA) layers 122, 124, 126, 128, and 130, a classifier layer 140, a query function 160, a general prompt 170, and a prompt pool 180. It will be appreciated that the model 100 may have more or less than the illustrated MSA layers and may also include other layers and elements not shown.

The general prompt 170 is used to encode knowledge that is common to all tasks that will be analyzed by the model 100. Thus, the general prompt 170 in task-invariant. As illustrated, the prompt pool 180 includes multiple prompts 181, 183, and 185. Thus, the prompt pool 180 includes T prompts that are used to encode information from T tasks, that is there is one prompt for each task. In some embodiments, the prompts 181, 183, and 185 are referred to as an “expert prompt” or E-prompt since their information is encoded from a specific task. As further illustrated, each of the prompts 181, 183, and 185 are associated as a value to a key, thus forming a key-value pair. For example, the prompt 181 is associated with a key 182, the prompt 183 is associated with a key 184, and the prompt 185 is associated with a key 186. The ellipses 187 illustrate that there may be additional prompt-key pairs that are not illustrated.

In operation, the model 100 receives a task input 110. The encoding/embedding layer 120 is configured to transform the task input 110 into a sequence like output that includes a sequence length and embedding dimension and to provide the sequence to the MSA layers. The encoding/embedding layer 120 also performs a deterministic embedding function on the task input 110 that encodes the task input to the key dimension so as to associate the task input with a key 115. Since the task input is encoded, it is referred to as encoded task input 110E to distinguish from the unencoded input.

The query function 160 also receives the encoded task input 110E and associated key 115 and queries the prompt pool 180 to determine a prompt to use for the encoded task input 110E. In one embodiment, this is done as match function 165 of the query function uses a distance metric to find which of the keys 182, 184, and 186 is closest to the key 115. The prompt that is associated with the closest key summarizes the task information of the prompt for the encoded task input 110E. In the illustrated embodiment, the key 184 is found to be closest to the key 115 and so the prompt 183 will summarize its task information for the encoded task input 110E.

As illustrated, the prompt 183 is then attached to multiple MSA layers, such as the MSA layers 128 and 130 shown in the figure. In addition, the general prompt 170 is attached to a MSA layer at the beginning of the model, such as the MSA layer 122 shown in the figure. The encoded task input 110E along with the attached prompt 183 and is then provided to the classifier layer 140, who performs a classification on the task input to generate an output 150.

Thus, the model 100 is able to perform many tasks by use of the prompt pool 180. That is, the model 100 does not need to know the boundaries between tasks since the model determines which prompt to use based on the encoding and query previously discussed. However, the prompt pool 180 is a fixed-size memory space and thus must know beforehand how many tasks it will be confronted with so as to ensure that there is a prompt in the prompt pool that is close enough to input task so as to be encoded onto the input as previously described. Accordingly, the model 100 is unable to be updated with new tasks without knowing beforehand how many tasks it will be confronted with or when the new tasks will arrive at the model 100.

### B. Aspects of Negative Selection Algorithm

A framework for novelty detection on stream data is inspired by the negative-selection algorithm, which discriminates between two sets, called Self and Other. The first one contains normal/known data patterns while the second contains any deviation exceeding an allowable variation. Self is a set of strings which is intended to be monitored. It could be, for example, a segmented file or a normal pattern activity of some system or process. Its complementary set, Other, consists of an ensemble of detectors, which are generated such that each of them fails to match the strings in Self. The matching rule is defined as successful if two strings are identical at least r contiguous positions, and unsuccessful otherwise. The set Self is continually monitored by matching its elements with detectors from Other. In the negative-selection algorithm, whenever a detector succeeds to match an element, a deviation from Self must have occurred, i.e., the model has identified a novelty.

### C. Aspects of the Current Invention

The current invention implements a novel framework for creating a dynamic prompt pool in a continual learning model in which new prompts are automatically added to the prompt pool whenever the continual learning model is confronted with a new task that has not been seen before. In addition, the framework automatically triggers retraining of the continual learning model when the new prompts are added so that the model is able to use the updated prompt pool for future tasks. The novel framework takes inspiration from the concepts of Self and Other from the negative-selection algorithm and incorporates these concepts in a novel way into prompting domain of the continual learning model.

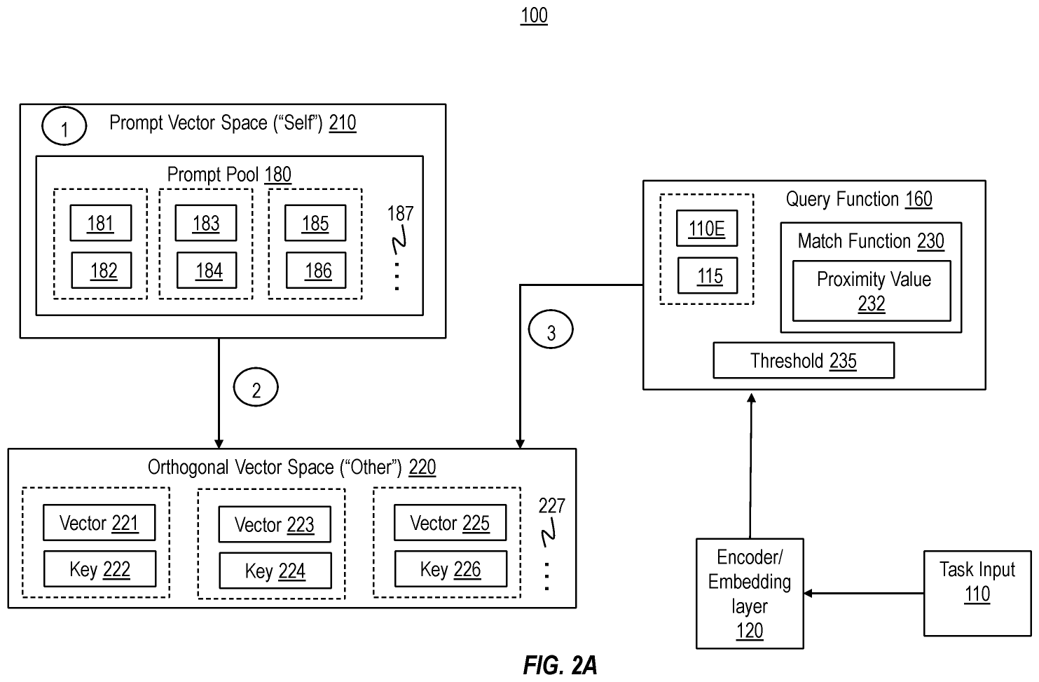

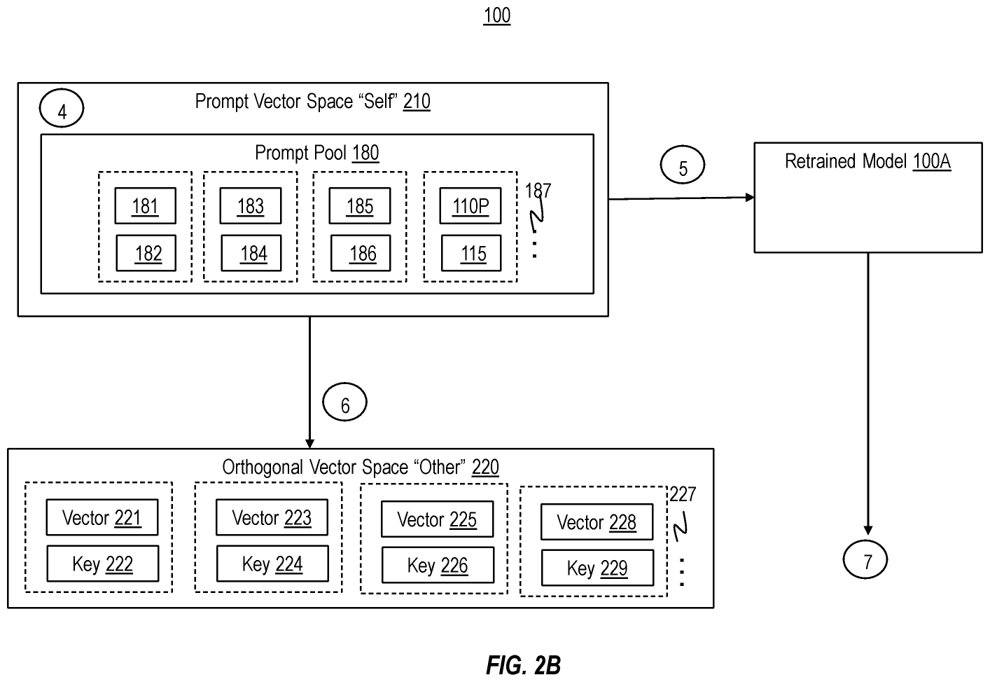

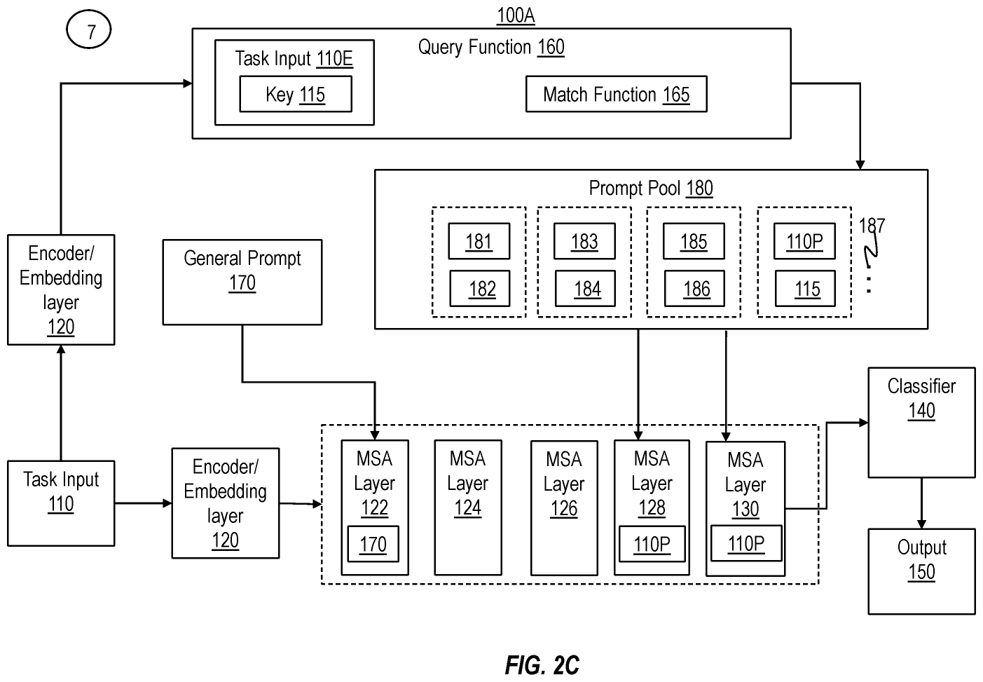

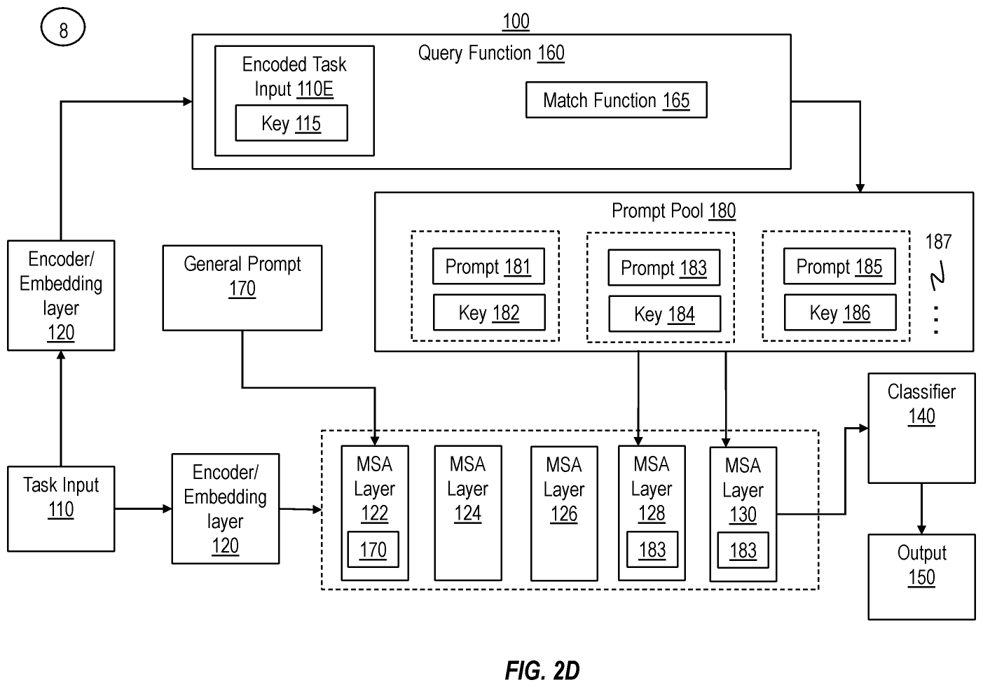

FIGS. 2A-2D illustrate an embodiment of the continual learning model 100 in which the novel framework for creating a dynamic prompt is implemented. Accordingly, for ease of explanation, these figures only show some of the elements of the model 100 previously discussed as well as the new elements added to the model as part of the novel framework.

In the novel framework, a broad task vector space V (with dim(V)=P>T), and T as the number of known tasks at a given time is defined. As shown in FIG. 2A, the broad task vector space is split into a closed linear subspace of V called the prompt vector space 210 (also referred to as Self vector space 210) and its orthogonal complement called the orthogonal vector space 220 (also referred to as Other vector space 220). Thus, the Other vector space 220 contains all vectors in V that are orthogonal to every vector in the prompt vector space 210. In the current invention, the Self vector space 210 is the prompt pool 180 and the vectors of the space are the prompts 181, 183, 185 (and potentially more as illustrated by the ellipses 187) that encode a single task as previously described.

A process flow of the current invention will now be explained with reference to FIGS. 2A-2D. At a step (1) shown in FIG. 2A, a deployed, trained continual learning model 100 is deployed. That is, the trained model performs T known tasks using a prompt pool containing T prompts, one for each known task. Thus, as shown in FIG. 2A, the model 100 includes prompt pool 180, which is also the Self vector space 210. At the start of the process the prompt pool 180 includes the prompt 181 and key 182, the prompt 183 and the key 184, the prompt 185 and the key 186, and potentially other prompt-key pairs as illustrated by the ellipses 187. In the embodiment, the trained, deployed model 100 may also include the other elements of the model that are not illustrated.

At a step (2), the Other vector space 220 is calculated as the orthogonal complement of the Self vector space 210. Thus the Other vector space 220 is a new model element not included in model 100 prior to the current invention. As illustrated in FIG. 2A, the Other vector space 220 includes a vector 221 and associated key 222, a vector 223 and associated key 224, a vector 225 and associated key 226, and potentially additional vectors and their associated keys as illustrated by the ellipses 227. As discussed previously, the vectors 221, 223, 225 and any other vectors illustrated by the ellipses 227 are those vectors in the task vector space V that are orthogonal to all of the prompts 181, 183, 185, and any other prompts as illustrated by the ellipses 187 that are included in the prompt pool 180 that comprises the Self vector space 210.

At a step (3), the trained, deployed model 100 receives the task input 110, which is then encoded by the encoder/embedding layer 120 into the encoded task input 110E with the associated key 115 and fed to the query function 160. The query function 160 includes a match function 230, which in some embodiments may correspond to the match function 165. In operation, the match function 230 is a proximity or distance function that determines the proximity of the key 115 to each of the keys 222, 224, 226, and potentially any key illustrated by the ellipses 227. In one embodiment, the match function 230 determines a proximity value 232 for the distance between each key of the Other vector space 220 and the key 115. The match function 230 then accesses a predetermined threshold 235, which may be determined by a specialist, and compares the proximity values 232 for each key of the Other vector space 220 to the threshold 235. If a proximity value 232 of a given key in the Other vector space 220 is greater than the threshold 235, then it is determined that the vector associated with the key matches the encoded task input 110E.

For example, suppose the proximity value 232 for distance between the key 115 and the key 222 is greater than the predetermined threshold 235, then it is determined that the encoded task input 110E matches with the vector 221. In the current invention, this means that the encoded task input 110E is a novelty with respect to the Self vector space 210. That is, the task associated with task input 110 has not been confronted with before by the model 100 and thus there is no corresponding prompt in the prompt pool 180 for the task. The case where the task input 110 is a novelty will be explained in more detail to follow with response to FIG. 2C.

However, if the proximity value 232 for each key of the Other vector space 220 is not above the predetermined threshold 235, then it is determined that none of the vectors in the Other vector space 220 match the encoded task input 110E. In the current invention, this means that the encoded task input 110E is not a novelty with respect to the Self vector space 210. That is, the task associated with task input 110 has been confronted with before by the model 100 and thus there is a corresponding prompt in the prompt pool 180 for the task. The case where the task input 110 is not a novelty will be explained in more detail to follow with respect to FIG. 2D.

FIG. 2B illustrates the case where the encoded task input 110E is a novelty and illustrates the process flow of the current invention. As discussed previously, the model 100 before the current invention would not be able to process the novel task input 110 since the model is unable to be updated. Advantageously, the novel framework of the current invention provides for a way to update the model 100 so that it can process the novel task input.

At step (4) the encoded task input 110E and its associated key 115 are added to the prompt pool 180, shown in FIG. 2B as a new prompt 110P. That is, the size of the prompt pool 180 is increased by the inclusion of the new prompt 110P that represents the encoded task input 110E and its associated key 115. As previously discussed, the model 100 before the inclusion of the novel framework of the current invention is not able to dynamically increase the size of the prompt pool and add new prompts.

At step (5), a flag is raised because the size of the prompt pool 180 has been increased. In response to the flag, an instruction to return to train mode is triggered, which in turn leads to the model 100 being retrained to account for the addition of the prompt 110P. In other words, the model is retrained so that the prompt 110P can be used along with the other prompts of the prompt pool 180 as a prompt for new task inputs that match the prompt 110P. In FIGS. 2B and 2C, the retrained model is denoted as 100A to signify that is has been retrained.

In one embodiment, the model 100A is retrained using all the data aligned with the Self vector space 210. The decision to use all the data aligned with the Self vector space 210 may be based on a determination of the available resources and the desired results. In other embodiments, the model 100A is retrained using only the data aligned with the vector in the Other vector space 220 that was used to determine the novelty of the encoded task input 110E. For example, suppose, as discussed previously, that the vector 221 was used to determine the novelty of the encoded task input 110E, then the data aligned with the vector 221 would be used to retrain the model 100A. In some embodiments, the may include providing some of the data to a human expert for labeling.

At step (6), the Other vector space 220 is recalculated to reflect the updates made to the prompt pool 180 so that the Other vector space 220 is again the orthogonal complement of the Self vector space 210. As shown in FIG. 2B, a vector 228 and its associated key 229 have been added to the Other vector space 220 to illustrate that the Other vector space 220 has been updated. Thus, the vectors 221, 223, 225, 228 and any other vectors illustrated by the ellipses 227 are those vectors in the task vector space V that are orthogonal to all of the prompts 181, 183, 185, 110P and any other prompts as illustrated by the ellipses 187 that are included in the prompt pool 180 that comprises the Self vector space 210.

At step (7), the retrained model 100A is deployed to be used to process new incoming task inputs. FIG. 2C shows the deployed retrained model 100A. As shown in the figure, the model 100A includes the enlarged prompt pool 180 that includes the prompt 110P and its associated key 115. After step (7), the process returns to step (3) and continues to monitor task inputs for any matches between the encoded input tasks and the vectors in the recalculated Other vector space 220. If matches are again found, thus indicating a novel task input, then the process of increasing the prompt pool size, recalculating the Other vector space 220, and retraining the model 100 are repeated again so that the model is able to process the new task input.

As discussed in FIG. 2A in relation to step (3) of the flow process, at determination is made if there are any matches between the key 115 associated with the encoded task input 110E and the keys associated with the vectors in the Other vector space 220. FIG. 2D illustrates the case where a match is not found and thus the encoded task input 110E is not a novelty.

As shown in FIG. 2D, the model 100 is not retrained because, since there was not a match, the existing prompt pool 180 should contain a prompt that will match the encoded task input 110E and thus there is no need to increase the size of the prompt pool or retrain the model. Thus, as shown at step (8), the model 100, when receiving the task input 110, is able to continue with its normal inference using the task input 110. The model will process the task input 110 and select a prompt 183 for the encoded task input 110E in the manner previously described in relation to FIG. 1. It will be noted that even though the processing of the task input 110 goes as according to FIG. 1, the step (3) of determining if there are any matches between the key 115 associated with the encoded task input 110E and the keys associated with the vectors in the Other vector space 220 is made before the model 100 processes the task input 110.

Returning to FIG. 2C, suppose that the retrained model 100A is again confronted with the task input 110 after the process of increasing the size of the prompt pool 180, recalculating the Other vector space 220, and retraining the model 100 discussed in relation to FIG. 2B have been completed. At step (3), a match between the key 115 of the encoded task input 110E will not be found since the enlarged prompt pool 180 now includes the prompt 110P that is specific to the encoded task input 110E. Accordingly, the model will process the encoded task input 110E (i.e., perform step (8)) in the manner discussed previously with respect to FIG. 1. In this case, however, the prompt 110P will be added the MSA layers 128 and 130 and the encoded task input 110E along with the attached prompt 110P and is provided to the classifier layer 140, who performs a classification on the task input to generate an output 150.

### D. Example Methods

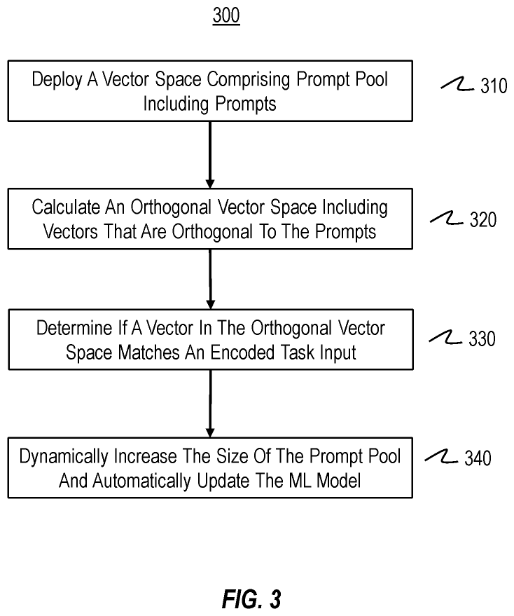

It is noted with respect to the disclosed methods, including the example method of FIG. 3, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 3, an example method 300 for dynamically increasing a prompt pool and automatically retraining a ML model is disclosed. The method 300 will be described in relation to one or more of the figures previously described, although the method 300 is not limited to any particular embodiment.

The method 300 includes deploying in a machine-learning (ML) model a prompt vector space, the prompt vector space comprising a prompt pool including vectors comprising T number of prompts representing T number of tasks that are performed by the ML model, each prompt encoding information about a specific one of the tasks (310). For example, as previously described the prompt vector space or Self vector space 210 comprises the prompt pool 180, which includes vectors comprising the prompts 181, 183, 185, and potentially more as illustrated by the ellipses 187. The prompts encode information about a specific task.

The method 300 includes calculating an orthogonal vector space as an orthogonal complement to the prompt vector space, the orthogonal vector space including vectors that are orthogonal to the vectors comprising the prompts of the prompt pool (320). For example, as previously described the orthogonal vector space or Other vector space 220 is calculated as an orthogonal complement to the prompt vector space 210. The orthogonal vector space 220 includes the vectors 221, 223, 225, and potentially more as illustrated by the ellipses 227 that are orthogonal to the prompts of the prompt vector space 210.

The method 300 incudes monitoring an encoded task input of the ML model to determine if the encoded task input matches a given one of the vectors in the orthogonal vector space (330). For example, as previously described it is determined if the encoded task input 110E matches one of the vectors of the orthogonal vector space 220. The determination is made in the manner described herein.

The method 300 includes when it is determined that the encoded task input matches the given one of the vectors in the orthogonal vector space, dynamically increasing the size of the prompt pool and automatically retraining the ML model to account for changes made to the prompt pool by increasing the prompt pool's size (340). For example, as previously described where the encoded task input 110E matches one of the vectors of the orthogonal vector space 220, then the prompt pool 180 is dynamically increased, in one embodiment by adding a new prompt, and the ML model is automatically retrained in the manner described herein.

### E. Further Example Embodiments

Following are some further example embodiments of the invention. These are presented only by way of example and are not intended to limit the scope of the invention in any way.

Embodiment 1. A method, comprising: deploying in a machine-learning (ML) model a prompt vector space, the prompt vector space comprising a prompt pool including vectors comprising T number of prompts representing T number of tasks that are performed by the ML model, each prompt encoding information about a specific one of the tasks; calculating an orthogonal vector space as an orthogonal complement to the prompt vector space, the orthogonal vector space including vectors that are orthogonal to the vectors comprising the prompts of the prompt pool; monitoring an encoded task input of the ML model to determine if the encoded task input matches a given one of the vectors in the orthogonal vector space; and when it is determined that the encoded task input matches the given one of the vectors in the orthogonal vector space, dynamically increasing the size of the prompt pool and automatically retraining the ML model to account for changes made to the prompt pool by increasing the prompt pool's size.

Embodiment 2. The method of embodiment 1, further comprising: recalculating the orthogonal vector space to account for the changes made to the prompt pool by increasing the prompt pool's size.

Embodiment 3. The method of embodiments 1-2, further comprising: when it is determined that encoded task input does not match one of the vectors in the orthogonal vector space, using the original prompt pool when the ML model performs the task associated with the encoded task input; and attaching one of the prompts of the original prompt pool that matches the encoded task input to the encoded task input when performing the task.

Embodiment 4. The method of embodiments 1-3, wherein determining if the encoded task input matches a given one of the vectors in the orthogonal vector space comprises: determining if a proximity value representing a distance between the encoded task input and each of the vectors in the orthogonal vector space is above a predefined threshold; and determining that the encoded task input matches the given one of the vectors when the proximity value for the given one of the vectors is above the predefined threshold.

Embodiment 5. The method of embodiment 4, wherein determining the proximity value comprises determining a distance between a key associated with each of the vectors in the orthogonal vector space and a key associated with the encoded task input.

Embodiment 6. The method of embodiments 1-5, wherein dynamically increasing the size of the prompt pool comprises adding a new prompt that represents the encoded task input to the prompt pool.

Embodiment 7. The method of embodiment 6, further comprising: recalculating the orthogonal vector space to account for the changes made to the prompt pool by increasing the prompt pool's size, wherein recalculating the orthogonal vector space comprises adding a new vector to the orthogonal vector space that is orthogonal to the new prompt added to the prompt pool.

Embodiment 8. The method of embodiments 1-7, wherein automatically retraining the ML model comprises using all data aligned with all the vectors in the prompt vector space as input for the retraining.

Embodiment 9. The method of embodiments 1-8, wherein automatically retraining the ML model comprises using data aligned with the vector of the orthogonal vector space that matched the encoded task input.

Embodiment 10. The method of embodiments 1-9, further comprising: deploying the automatically retrained ML model, the retrained ML model including the dynamically increased prompt pool; using the dynamically increased prompt pool when the ML model performs the task associated with the encoded task input; and attaching a new prompt of the dynamically increased prompt pool that represents the encoded task input and that matches the encoded task input to the encoded task input when performing the task.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, engine, agent, or the like may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to conduct executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

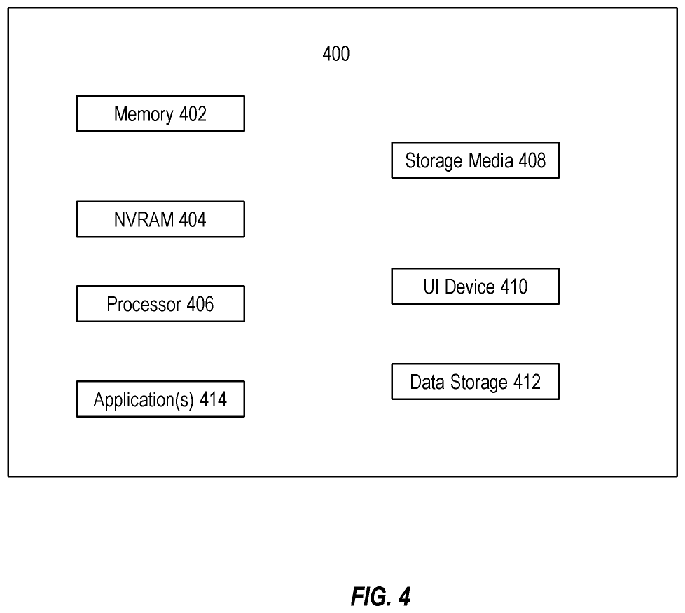

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the components of the memory 402 of the physical computing device 400 may take the form of solid-state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
deploying in a machine-learning (ML) model a prompt vector space, the prompt vector space comprising a prompt pool including vectors comprising T number of prompts representing T number of tasks that are performed by the ML model, each prompt encoding information about a specific one of the tasks;
calculating an orthogonal vector space as an orthogonal complement to the prompt vector space, the orthogonal vector space including vectors that are orthogonal to the vectors comprising the prompts of the prompt pool;
monitoring an encoded task input of the ML model to determine if the encoded task input matches a given one of the vectors in the orthogonal vector space; and
when it is determined that the encoded task input matches the given one of the vectors in the orthogonal vector space, dynamically increasing a size of the prompt pool and automatically retraining the ML model to account for changes made to the prompt pool by increasing the prompt pool's size.

2. The method of claim 1, further comprising:
recalculating the orthogonal vector space to account for the changes made to the prompt pool by increasing the prompt pool's size.

3. The method of claim 1, further comprising:
when it is determined that encoded task input does not match one of the vectors in the orthogonal vector space, using the prompt pool without dynamically increasing its size when the ML model performs the task associated with the encoded task input; and
attaching one of the prompts of the prompt pool that is not dynamically increased that matches the encoded task input to the embedding of the input when performing the task.

4. The method of claim 1, wherein determining if the encoded task input matches a given one of the vectors in the orthogonal vector space comprises:
determining if a proximity value which is a function of a distance between the encoded task input and each of the vectors in the orthogonal vector space is above a predefined threshold; and
determining that the encoded task input matches the given one of the vectors when the proximity value for the given one of the vectors is above the predefined threshold.

5. The method of claim 4, wherein determining the proximity value comprises determining a distance between a key associated with each of the vectors in the orthogonal vector space and a key associated with the encoded task input.

6. The method of claim 1, wherein dynamically increasing the size of the prompt pool comprises adding a new prompt that represents the encoded task input to the prompt pool.

7. The method of claim 6, further comprising:
recalculating the orthogonal vector space to account for the changes made to the prompt pool by increasing the prompt pool's size,
wherein recalculating the orthogonal vector space comprises adding a new vector to the orthogonal vector space that is orthogonal to the vectors contained in the prompt pool.

8. The method of claim 1, wherein automatically retraining the ML model comprises using data aligned with all the vectors in the prompt vector space as input for the retraining.

9. The method of claim 1, wherein automatically retraining the ML model comprises using data aligned with the vector of the orthogonal vector space that matched the encoded task input.

10. The method of claim 1, further comprising:
deploying the automatically retrained ML model, the retrained ML model including the dynamically increased prompt pool;
using the dynamically increased prompt pool when the ML model performs the task associated with the encoded task input; and
attaching a new prompt of the dynamically increased prompt pool that represents the encoded task input and that matches the encoded task input to the embedding of the input when performing the task.

11. A non-transitory storage medium having stored therein instructions that are executable by one or more hardware processors to perform operations comprising:
deploying in a machine-learning (ML) model a prompt vector space, the prompt vector space comprising a prompt pool including vectors comprising T number of prompts representing T number of tasks that are performed by the ML model, each prompt encoding information about a specific one of the tasks;
calculating an orthogonal vector space as an orthogonal complement to the prompt vector space, the orthogonal vector space including vectors that are orthogonal to the vectors comprising the prompts of the prompt pool;
monitoring an encoded task input of the ML model to determine if the encoded task input matches a given one of the vectors in the orthogonal vector space; and
when it is determined that the encoded task input matches the given one of the vectors in the orthogonal vector space, dynamically increasing a size of the prompt pool and automatically retraining the ML model to account for changes made to the prompt pool by increasing the prompt pool's size.

12. The non-transitory storage medium of claim 11, further comprising the following operations:
recalculating the orthogonal vector space to account for the changes made to the prompt pool by increasing the prompt pool's size.

13. The non-transitory storage medium of claim 11, further comprising the following operations:
when it is determined that encoded task input does not match one of the vectors in the orthogonal vector space, using the prompt pool without dynamically increasing its size when the ML model performs the task associated with the encoded task input; and
attaching one of the prompts of the prompt pool that is not dynamically increased that matches the encoded task input to the embedding of the input when performing the task.

14. The non-transitory storage medium of claim 11, wherein determining if the encoded task input matches a given one of the vectors in the orthogonal vector space comprises:
determining if a proximity value which is a function of a distance between the encoded task input and each of the vectors in the orthogonal vector space is above a predefined threshold; and
determining that the encoded task input matches the given one of the vectors when the proximity value for the given one of the vectors is above the predefined threshold.

15. The non-transitory storage medium of claim 14, wherein determining the proximity value comprises determining a distance between a key associated with each of the vectors in the orthogonal vector space and a key associated with the encoded task input.

16. The non-transitory storage medium of claim 11, wherein dynamically increasing the size of the prompt pool comprises adding a new prompt that represents the encoded task input to the prompt pool.

17. The non-transitory storage medium of claim 16, further comprising the following operations:
recalculating the orthogonal vector space to account for the changes made to the prompt pool by increasing the prompt pool's size,
wherein recalculating the orthogonal vector space comprises adding a new vector to the orthogonal vector space that is orthogonal to the vectors contained in the prompt pool.

18. The non-transitory storage medium of claim 11, wherein automatically retraining the ML model comprises using data aligned with the vectors in the prompt vector space as input for the retraining.

19. The non-transitory storage medium of claim 11, wherein automatically retraining the ML model comprises using data aligned with the vector of the orthogonal vector space that matched the encoded task input.

20. The non-transitory storage medium of claim 11, further comprising the following operations:
deploying the automatically retrained ML model, the retrained ML model including the dynamically increased prompt pool;
using the dynamically increased prompt pool when the ML model performs the task associated with the encoded task input; and
attaching a new prompt of the dynamically increased prompt pool that represents the encoded task input and that matches the encoded task input to the embedding of the input when performing the task.
